(19) United States
(12) Patent Application Publication
(10) Pub. No.: US 2007/0034068 A1
(43) Pub. Date: Feb. 15, 2007

(54) Paper cutter having an inverted corner device

(76) Inventor: Tung-Lung Chiang, Tou Liu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/202,345

(22) Filed: Aug. 12, 2005

(51) Int. Cl. B26D 1/00

(52) U.S. Cl. 83/679

(57) ABSTRACT

An inverted corner device installed on a paper cutter includes a base, a fixed knife, and a movable knife. The base is disposed on the paper cutter. The fixed knife is disposed on the base. The fixed knife includes an inverted corner blade. The movable knife includes a corresponding inverted corner cutting edge adjacent to the inverted corner blade. The movable knife further includes elastic members. Each of the elastic members has two ends with one end holding against the movable knife and the other end holding against the base. When the paper corner of a piece of paper is placed between the fixed knife and the movable knife, the movable knife is pressed down to cut the paper corner into an inverted corner.

### BACKGROUND OF THE INVENTION

1. Field of the Invention

The present invention relates to a paper cutter having an inverted corner device, and the inverted corner device has a fixed knife disposed on a base and a movable knife corresponding to the fixed knife to cut a paper corner into an inverted corner.

2. Description of the Related Art

Most of conventional paper cutters have a single cutter or a sliding knife for cutting paper, but after the paper is cut, the paper corners are very sharp and may injure users. Furthermore, the conventional paper cutters are not provided with an inverted corner device.

### SUMMARY OF THE INVENTION

Therefore, it is a primary objective of the present invention to provide a paper cutter having an inverted corner device. The inverted corner device comprises a base, a fixed knife, and a movable knife. The base is disposed on the paper cutter. The fixed knife is disposed on the base. The fixed knife includes an inverted corner blade. The movable knife includes a corresponding inverted corner cutting edge adjacent to the inverted corner blade. The movable knife further comprises elastic members. Each of the elastic members has two ends with one end holding against the movable knife and the other end holding against the base. When the movable knife moves with respect to the fixed knife, the inverted corner cutting edge is pressed down with respect to the inverted corner blade to cut the paper corner of a piece of paper.

The elastic members are springs.

The movable knife has one end pivotally connected to the base and is capable to move with respect to the fixed knife.

Therefore, the paper corner of a piece of paper on the paper cutter can be cut into an inverted corner, and it thus can prevent the sharp paper corner of the paper from cutting or injuring users.

### BRIEF DESCRIPTION OF THE DRAWINGS

FIG. 1 is an exploded view of the present invention;

FIG. 2 is a perspective view of the present invention applied to a paper cutter;

FIG. 3 is a top view of the present invention in an operating status;

FIG. 4 is a cross-sectional view of the present invention in an operating status, and

FIG. 5 is a schematic view of an inverted corner cut from a piece of paper according to the present invention.

### DETAILED DESCRIPTION OF THE PREFERRED EMBODIMENTS

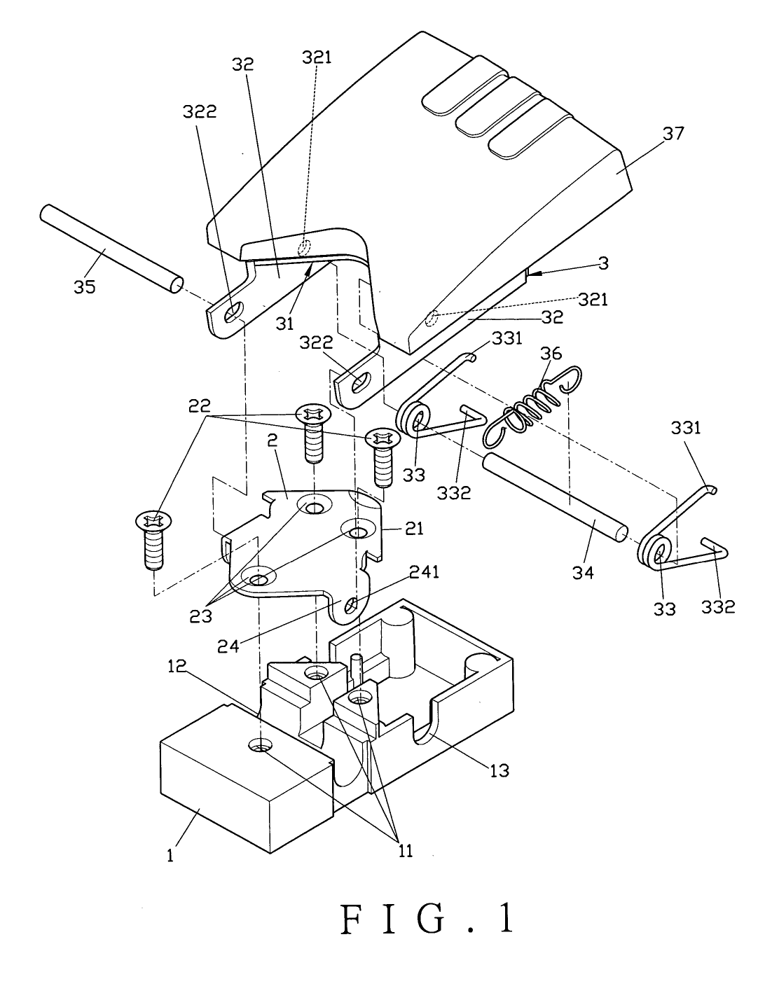

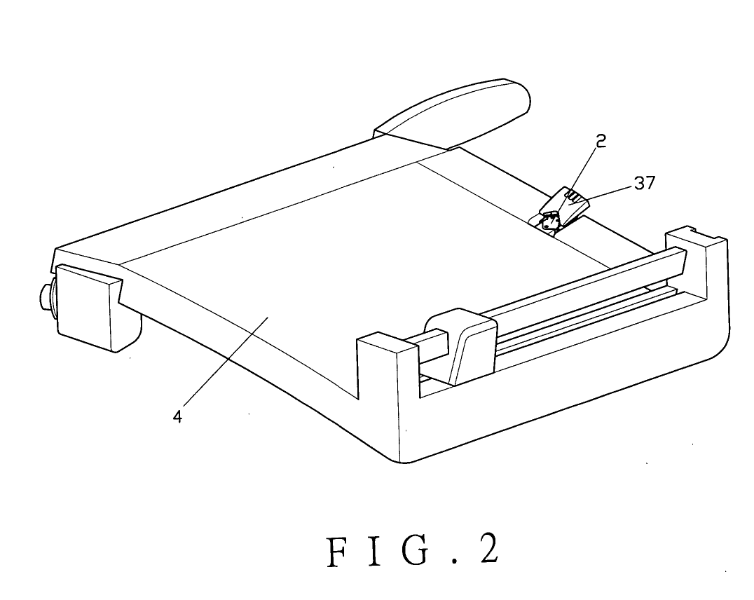

Referring to FIGS. 1 and 2, a paper cutter 4 is provided with an inverted corner device. The inverted corner device comprises a base 1, a fixed knife 2, and a movable knife 3.

The base 1 includes screw holes 11 and grooves 12, 13 for avoiding other components.

The fixed knife 2 includes an inverted corner blade 21 and bolts 22 passing through through holes 23 thereon and being fixed into the screw holes 11 of the base 1. The fixed knife 2 is provided with a pair of protruding ears 24 at two sides. Each of the protruding ears 24 has a through hole 241.

The movable knife 3 includes a corresponding inverted corner cutting edge 31 adjacent to the inverted corner blade 21. The movable knife 3 is provided with a pair of side boards 32 at two sides. The middle section and the front section of each of the side boards 32 are provided with a through hole 321 and a long hole 322, respectively. The movable knife 3 further comprises elastic members 33 to hold against the movable knife 3. Each elastic member 33 as shown in the figure is a spring having two ends 331, 332. The end 331 of each elastic member 33 holds against the movable knife 3, and the other end 332 holds against the base 1. The elastic members 33 as shown in the figure are torque springs fixed to the through hole 321 by passing a transversal rod 34. A pivotal pin 35 is inserted through the long holes 322 of the side boards 32 and the through holes 241 of the protruding ears 24 of the fixed knife 2, so that the moveable knife 3 can be pressed downward with respect to the fixed knife 2. The transversal rod 34 and the pivotal pin 35 are connected by another spring 36. The inverted corner cutting edge 31 of the movable knife 3 is closely in contact with the inverted corner blade 21 of the fixed knife 2 for cutting an inverted corner from the paper. A pad 37 is provided on the movable knife 3 for users to press.

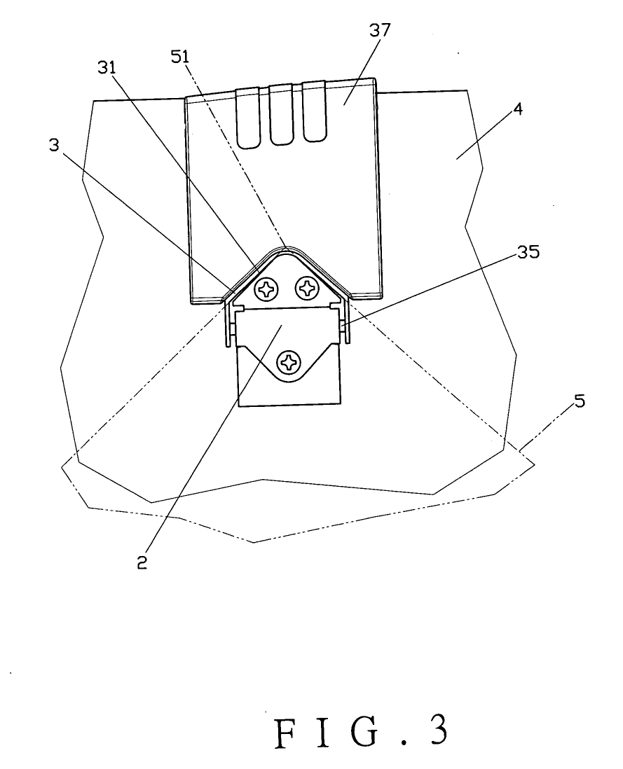

Referring to FIG. 3, a paper corner 51 of a piece of paper 5 is placed between the fixed knife 2 and the movable knife 3 of the inverted corner device on the paper cutter 4, such that the paper corner 51 is on the fixed knife 2, and the sharp corner is extended under the movable knife 3.

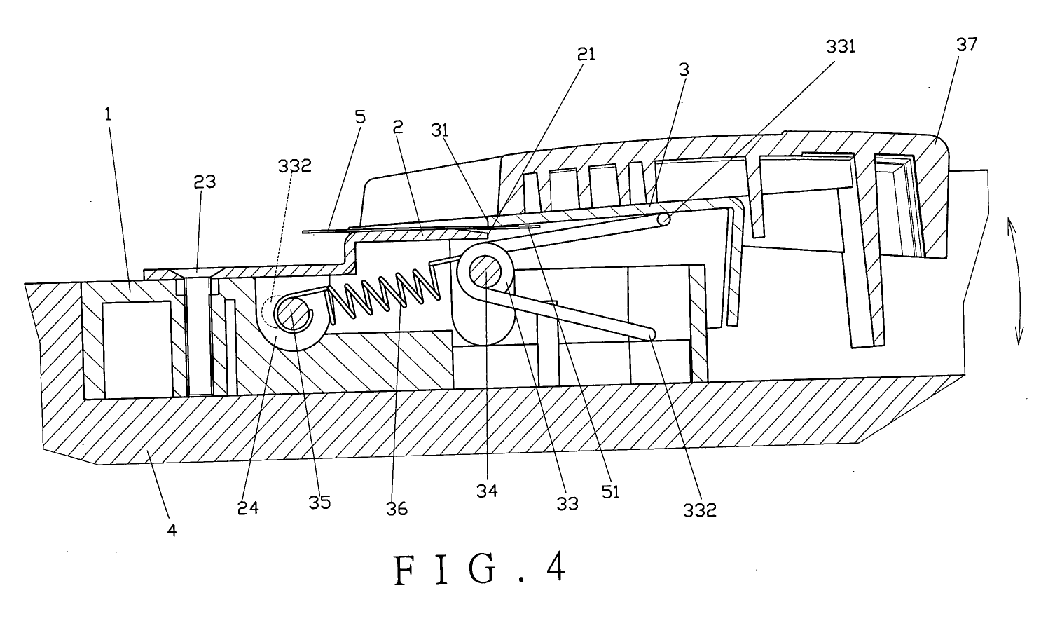

Referring to FIG. 4, a user presses the pad 37 of the movable knife 3 on the paper cutter 4 to press the movable knife 3 down with respect to the fixed knife 2, so that the inverted corner cutting edge 31 is pressed down with respect to the inverted corner blade 21 to cut the paper corner 51 into an inverted corner, and it thus can avoid the paper corner 51 of the paper 5 from cutting users.

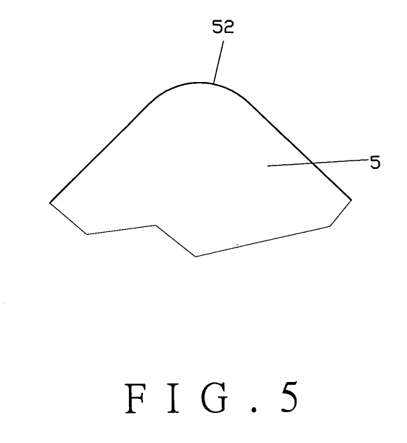

FIG. 5 shows that the paper corner of the paper 5 is cut into an inverted corner 52.

What is claimed is:

1. A paper cutter having an inverted corner device, said inverted corner device comprising a base, a fixed knife and a movable knife;
said fixed knife being disposed on said base and comprising an inverted corner blade;
said movable knife comprising a corresponding inverted corner cutting edge adjacent to said inverted corner blade, said movable knife further comprising elastic members, each of said elastic members having two ends with one end holding against said movable knife and the other end holding against said base;
thereby when said movable knife moves with respect to said fixed knife, said inverted corner cutting edge pressing said corresponding inverted corner blade for cutting paper.

2. The paper cutter having an inverted corner device of claim 1, wherein said elastic members are springs.

3. The paper cutter having an inverted corner device of claim 1, wherein said movable knife has one end pivotally connected to said base and is capable of moving with respect to said fixed knife.
